(19) United States
(12) Patent Application Publication
(10) Pub. No.: US 2007/0245038 A1
(43) Pub. Date: Oct. 18, 2007

(54) System and method for user-controlled connection of computer peripheral devices

(75) Inventor: Ying-Chih Lu, Taipei (TW)

Correspondence Address: EDWARDS ANGELL PALMER & DODGE LLP, P.O. BOX 55874, BOSTON, MA, 02205, US

(73) Assignee: Inventec Corporation, Taipei (TW)

(21) Appl. No.: 11/395,067

(22) Filed: Mar. 30, 2006

(51) Int. Cl. G06F 3/00

(52) U.S. Cl. 710/8

(57) ABSTRACT

A system and method for user-controlled connection of computer peripheral devices, applicable in a computer platform, is provided for allowing users to control the order and the configuration data source of initializing peripheral devices coupled to the computer platform. A process order specifying module allows the users to specify an order in which the peripheral devices are to be processed. A configuration data source specifying module allows the users to specify a configuration data source for the peripheral devices. A configuration data processing module is used to perform initialization of the peripheral devices according to the order specified by the process order specifying module by reading the required configuration data obtained from the specified configuration data source, so as to allow a CPU to successfully communicate with the peripheral devices.

### FIELD OF THE INVENTION

The present invention relates to a computer technology, and more particularly, to a system and method for user-controlled connection of computer peripheral devices coupled to a computer platform that allows users to specify the order and source of configuration data of initialization of the peripheral devices.

### BACKGROUND OF THE INVENTION

PCI (Peripheral Component Interconnect) is a peripheral interconnecting interface often employed by computer platforms, which allows the CPU (Central Processing Unit) of a computer platform to be connected to various peripheral devices, such as a display, a hard disk drive, a CD-ROM, a network switch and so on, so that the CPU can communicate with these peripheral devices.

PCI peripheral devices are usually built in with an Option Read Only Memory (OPROM), which stores configuration data of the PCI peripheral device to which it belongs. The configuration data is required when connecting the peripheral device to the computer platform. In other words, the computer platform to which the PCI peripheral device is connected can directly read the configuration data stored in the OPROM and perform initialization on the PCI peripheral device such that the computer platform may communicate with the PCI peripheral device. Basically, the access speed of a RAM (Random Access Memory) is greater than a ROM. Thus, in actual implementation, a specific storage space in the RAM of the computer platform, often referred to as a Shadow RAM, is dedicated to store a copy of the configuration data stored in the OPROM of the PCI peripheral device in order to enhance the overall processing efficiency of the peripherals.

In actual operations, the current computer platform will process various OPROM configuration data of the various peripheral devices according to a fixed order. For example, SATA peripheral devices on the main board is usually given the first priority, then SCSI peripheral devices on the main board, then NIC peripheral devices on the main board, then PCIX-slot peripheral devices, and finally the PCIE-slot peripheral devices. However, OPROM configuration data processed in such a fixed order in actual implementation has at least the following two disadvantages.

The first advantage is that the overall peripheral processing efficiency is degraded. In actual implementation, the usual capacity of a shadow RAM in a computer platform is only 128 KB (C0000h-DFFFFh), so it can only support a certain amount of peripheral devices. For example, the amount of OPROM configuration data of a mandatory and first-priority PCI peripheral device (e.g. a VGA video control card) is 32 KB, then it occupies 32 KB storage space in the Shadow RAM during actual implementation, thus there is only 96 KB (128 KB-32 KB) of storage space available in the Shadow RAM. Under this circumstance, the processing order of rest of the PCI peripherals will affect the overall peripheral processing efficiency of the computer platform. For example, it is assumed the amount of OPROM original configuration data of four PCI peripheral devices PCI(1), PCI(2), PCI(3) and PCI(4) are 64 KB, 64 KB, 32KB, and 24 KB, respectively, and the amount of data after actual execution are 6 KB, 32 KB, 32 KB and 16 KB, respectively. If the four PCI peripheral devices are processed in the order of PCI(1)→PCI(2)→PCI(3)→PCI(4), under the circumstance that there is only 96 KB of memory available in the Shadow RAM, all four PCI peripheral devices can be processed, as shown in the table below.

| | Amount of | | |
|---|---|---|---|
| | original | Amount of data | |
| Order of | configuration | after actual | Shadow RAM |
| process | data | execution | available space |
| Order 1: | 64 KB | 6 KB | 96 − 6 = 90 KB |
| PCI(1) | | | |
| Order 2: | 64 KB | 32 KB | 90 − 32 = 58 KB |
| PCI(2) | | | |
| Order 3: | 32 KB | 32 KB | 58 − 32 = 26 KB |
| PCI(3) | | | (>24 KB) |
| Order 4: | 24 KB | 16 KB | 26 − 16 = 10 KB |
| PCI(4) | | | |

On the contrary, if the four PCI peripheral devices are processed instead in the order: PCI(2)→PCI(3)→PCI(4)→PCI(1), then only the first three PCI peripheral devices can be processed, as shown in the table below.

| | Amount of | | |
|---|---|---|---|
| | original | Amount of data | |
| Order of | configuration | after actual | Shadow RAM |
| process | data | implementation | available space |
| Order 1: | 64 KB | 32 KB | 96 − 32 = 64 KB |
| PCI(2) | | | |
| Order 2: | 32 KB | 32 KB | 64 − 32 = 32 KB |
| PCI(3) | | | |
| Order 3: | 24 KB | 16 KB | 32 − 16 = 16 KB |
| PCI(4) | | | (<64 KB) |
| Order 4: | 64 KB | X | X |
| PCI(1) | | | |

As shown in the table above, after PCI(4) is processed, the amount of space left in the Shadow RAM is only 16 KB, which is insufficient to load the original configuration data (64 KB) of PCI(1).

The second disadvantage is that it may cause the computer platform to have an abnormal operating status or the “system hanging” phenomenon, for example, system hanging during execution of BIOS POST or during loading of the operating system or that some booting device (e.g. CD-ROM) is disabled etc. This is because some situations arisen during the processing OPROM configuration data, when processed in a certain order, may cause system conflict and possibly system banging phenomenon to occur. These situations arises for example when hooking Int 13 h (i.e. interrupt service routine for accessing hard disk drive) or hooking Int 19 h (i.e. interrupt service routine for loading the operating system) is required, EBDA is required to be a memory area during runtime, supporting some of the BBS (BIOS Boot Specification) functions is required or the PCI peripheral device requires the use of PCI interrupt signal to initialize its own interrupt service routine. Therefore, these problems can be resolved by changing the order these peripheral devices are processed.

Furthermore, the OPROM configuration data of some PCX/PCIE peripheral devices may search for the same device controller currently exists on the system of the computer platform to perform initialization. For example, a LSI 1020a SCSI controller and a LSI 1030 SCSI controller may have the same DIDNVID (Device ID/endor ID). Thus, if LSI 1030 SCSI controller is one of the peripheral devices of the main board, then its OPROM configuration data must also be stored in the BIOS. When the circuit card (which also comprises OPROM) of the LSI 1020A controller is inserted into the computer platform and the BIOS POST is being executed, if the OPROM configuration data of the LSI 1030 controller in the BIOS is used for the initializing procedure, then the computer platform performs initializing procedure for the LSI 1030 controller on the main board and the LSI 1020A controller simultaneously. Thereby, the LSI 1030 and 1020A controllers can function normally (i.e. all hard disk drives attached to the LSI 1030 and 1020A controllers can be connected to the computer platform).

However, when the BIOS POST is executed, if the OPROM of the circuit card of the LSI 1020A controller is used for the initializing procedure, then the LSI 1030 controller may not be able to function normally, that is, the initialization of the LSI 1030 controller fails. As a result, the computer platform is unable to connect to any of the hard disk drives attached to the LSI 1030 controller. This may be because the OPROM configuration data on the circuit card is an older version that cannot be used to achieve successful initialization while the OPROM configuration data on the main board is a newer version that can be used to achieve successful initialization. In addition, the majority of the computer platforms do not allow peripheral devices to choose OPROM configuration data stored in the BIOS of the main board for initialization, thus for some PCIX/PCIE peripheral devices that do not have OPROM, they cannot be successfully initialized by using OPROM configuration data with the same DID/VID in the BIOS.

### SUMMARY OF THE INVENTION

In the light of forgoing drawbacks, an objective of the present invention is to provide a system and method for user-controlled connection of computer peripheral devices coupled to a computer platform that allows users to specify a particular order in which the peripheral devices are initialized by the computer platform. Another objective of the present invention is to provide a system and method for user-controlled connection of computer peripheral devices coupled to a computer platform that allows users to specify a configuration data source (BIOS on the main board or OPROM on a circuit card) from which the configuration data for initializing the peripheral devices are read.

The system and method for user-controlled connection of computer peripheral devices of the present invention is applied to a computer platform such as a desktop personal computer, a notebook computer or a network server. The computer platform is provided with a peripheral connecting interface for connecting to the plurality of peripheral devices, such as a PCI peripheral connecting interface.

The method for user-controlled connection of computer peripheral devices of the present invention comprises: (1) specifying an order in which the peripheral devices are to be processed by a user; (2) specifying a configuration data source for each of the peripheral devices by the user, wherein the configuration data source is selected from the group consisting of the OPROM of each of the peripheral devices and the configuration data storage areas in the boot control unit; and (3) performing initialization for the peripheral devices according to the specified order by reading the required configuration data obtained from the specified configuration data source, so as to allow the CPU to successfully communicate with the peripheral devices.

In one embodiment, the system for user-controlled connection of computer peripheral devices of the present invention comprises: (A) a process order specifying module for allowing a user to specify an order in which the peripheral devices are to be processed; (B) a configuration data source specifying module for allowing the user to specify a configuration data source for the peripheral devices, wherein the configuration data source is selected from the group consisting of the OPROM of each of the peripheral devices and the configuration data storage areas in the boot control unit; and (C) a configuration data processing module for performing initialization of the peripheral devices according to the order specified by the process order specifying module by reading the required configuration data obtained from the configuration data source specified by the configuration data source specifying module, so as to allow the CPU to successfully communicate with the peripheral devices.

The system and method for user-controlled connection of computer peripheral devices of the present invention is connected to a computer platform for allowing users to control the order and the configuration data source of initializing peripheral devices coupled to the computer platform. This allows the computer platform to orderly process the configuration data of the peripheral devices through a Shadow RAM with limited storage and to successfully connect and exchange data with the peripheral devices. In addition, by virtue of the present invention, the computer platform can always support the largest number of peripheral devices possible. Moreover, the processing of configuration data is made more efficient by avoiding conflicts that may cause system hanging phenomenon.

### BRIEF DESCRIPTION OF THE DRAWINGS

The present invention can be more fully understood by reading the following detailed description of the preferred embodiments, with reference made to the accompanying drawings, wherein:

FIG. 1 shows the system for user-controlled connection of computer peripheral devices of the present invention connected to a computer platform;

FIG. 2 shows an object-oriented component model of a framework of the system for user-controlled connection of computer peripheral devices 100 according to one embodiment of the present invention;

FIG. 3A is an exemplary screen snapshot of a user control interface on a computer monitor illustrating a process order specifying module in the system for user-controlled connection of computer peripheral devices of the present invention; and

FIG. 3B is an exemplary screen snapshot of a user control interface on a computer monitor illustrating a configuration data source specifying module in the system for user-controlled connection of computer peripheral devices of the present invention.

### DETAILED DESCRIPTION OF THE EMBODIMENTS

The present invention is described by the following specific embodiments. Those with ordinary skills in the arts can readily understand the other advantages and functions of the present invention after reading the disclosure of this specification. The present invention can also be implemented with different embodiments. Various details described in this specification can be modified based on different viewpoints and applications without departing from the scope of the present invention.

Embodiments of the system and method for user-controlled connection of computer peripheral devices are described in details in conjunction with the appended drawings.

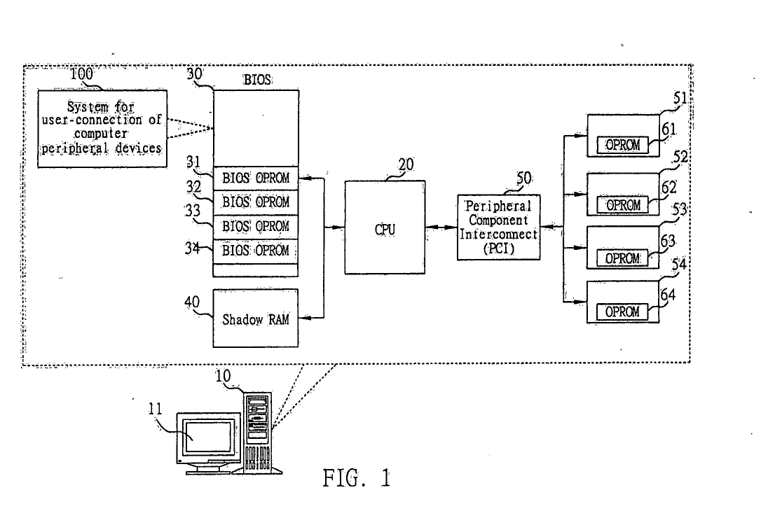

FIG. 1 shows an application of the system for user-controlled connection of computer peripheral devices according to an embodiment of the present invention. As shown, the system for user-controlled connection of computer peripheral devices 100 of the present invention is connected to a computer platform 10, such as a desktop computer, a notebook computer, a network server and so on. The computer platform 10 is provided with at least one CPU (Central Processing Unit) 20, a boot control unit 30, a Shadow RAM 40, a specific type of peripheral connecting interface 50. The boot control unit 30 is for example a BIOS (Basic Input/Output System) chip module and the peripheral connecting interface 50 is for example a PCI peripheral connecting interface used for connecting to one or more peripheral devices. In the embodiment of FIG. 1, there are four peripheral devices 51, 52, 53 and 54 with a built-in Option Read Only Memory (OPROM) 61, 62, 63 and 64, respectively. Each of the OPROM is pre-stored with configuration data (hereinafter “original configuration data”) related to initializing of the respective peripheral device to which the OPROM belongs. In addition, a plurality of configuration data storage area 31, 32, 33 and 34 are predefined in the storage space of the BIOS boot control unit 30 that store a group of OPROM configuration data burnt into the BIOS boot control unit 30 by a manufacturer in advance. These OPROM configuration data are configuration data frequently used or of the peripheral devices on the main board. In the embodiment of FIG. 1, the four configuration data storage area 31, 32, 33 and 34 respectively store the configuration data required for initializing peripheral devices 51, 52, 53 and 54, i.e. the original configuration data stored in OPROM 61, 62, 63 and 64, respectively. Thus, when performing initialization, the original configuration data of the peripheral devices 51, 52, 53 and 54 can be respectively read from two sources (hereafter “configuration data sources”): (1) the OPROM 61, 62, 63 and 64 of the peripheral devices 51, 52, 53 and 54 and (2) the configuration data storage area 31, 32, 33 and 34 in the BIOS boot control unit 40.

In actual implementation, the system for user-controlled connection of computer peripheral devices 100 provides users with the ability to control the process of connecting the peripheral devices. More specifically, users are allowed to specify a particular processing order and the required configuration data source for these peripheral devices 51, 52, 53 and 54, such that the computer platform 10 may execute connection between the CPU 20 and the peripheral devices 51, 52, 53 and 54 accordingly.

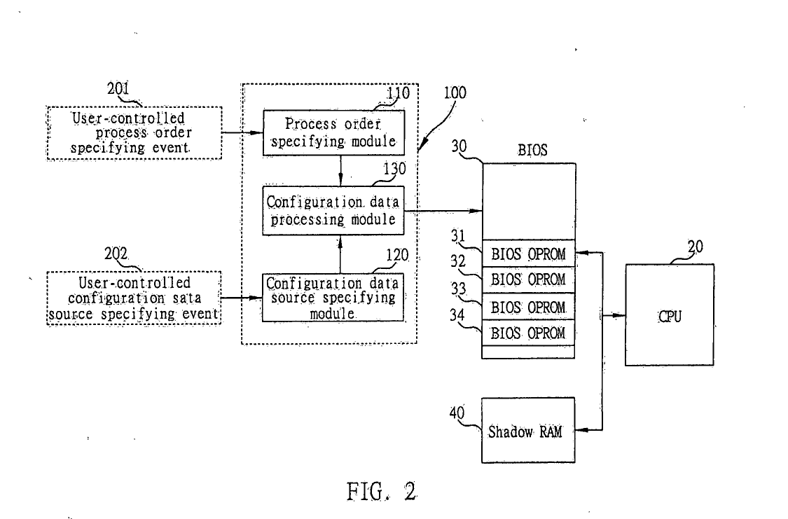

FIG. 2 shows an object-oriented component model of a framework of the system for user-controlled connection of computer peripheral devices 100 according to one embodiment of the present invention, which comprises: (A) a process order specifying module 110; (B) a configuration data source specifying module 120; and (C) a configuration data processing module 130. In actual implementation, the system for user-controlled connection of computer peripheral devices 100 can be realized entirely by a computer program that can be integrated to the BIOS of the computer platform 10 as an add-on module, and the required peripheral connection functionality is therefore achieved by the CPU 20 executing this computer program.

The individual attribute and functionality of modules 110, 120 and 130 comprising the system for user-controlled connection of computer peripheral devices 100 of the present invention are described as follow.

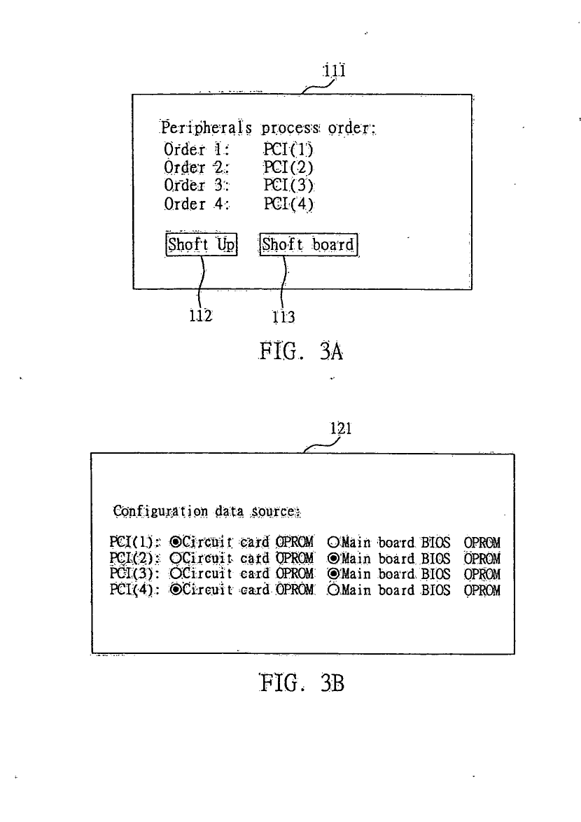

The process order specifying module 110 is used to allow the users to specify process order, that is, it sets a process order for peripheral devices 51, 52, 53 and 54 in response to a user-controlled process order specifying event 201. In actual implementation, the process order specifying module 110 may comprise a user control interface 111 shown on a display 11 of the computer platform, as illustrated in FIG. 3A. The user control interface 111 allows the users to specify a process order for the peripheral devices 51, 52, 53 and 54 by for example selecting a code representing a certain peripheral device and changing the order of the peripheral devices via [Shift Up] and [Shift Down] keys 113. It should be noted that the user control interface 111 shown in FIG. 3A is only an exemplary embodiment; the actual implementation may include many other ways of displaying and manipulating methods.

The configuration data source specifying module 120 is used to allow the users to specify configuration data sources, that is, it sets the required configuration data source (e.g. a “circuit card OPROM” or a “main board BIOS OPROM”) for each of the peripheral devices 51, 52, 53 and 54 in response to a user-controlled configuration data source specifying event 202. In actual implementation, the configuration data source specifying module 120 may comprise a user control interface 121 shown on the display 11 of the computer platform, as illustrated in FIG. 3B. The user control interface 121 allows the users to specify a configuration data source for individual peripheral devices 51, 52, 53 and 54. If the user selects the option of “circuit card OPROM”, then the specified configuration data source is the OPROM 61, 62, 63 and 64 on the peripheral devices 51, 52, 53 and 54; else, if the user selects the option of “main board BIOS OPROM”, then the specified configuration data source is the configuration data storage area 31, 32, 33 and 34 of the BIOS boot control unit 30. It should be noted that the user control interface 121 shown in FIG. 3B is only an exemplary embodiment; the actual implementation may include many other ways of displaying and manipulating methods.

The configuration data processing module 130 is used to perform initialization for the peripheral devices 51, 52, 53 and 54 in the order specified via the process order specifying module 110 and using the configuration data stored in the configuration data source specified by the configuration data source specifying module 120, so as to enable connection and data exchange between the CPU and the peripheral devices 51, 52, 53 and 54. For example, in the embodiment of FIG. 3B, the user chooses the “circuit card OPROM” as the configuration data source for the peripheral device 51 (i.e. PCI (1)), so the configuration data processing module 130 reads the required configuration data from the OPROM 61 of the peripheral device 51; the user chooses the “main board OPROM” as the configuration data source for the peripheral device 52 (i.e. PCI (2)), then the configuration data processing module 130 reads the required configuration data from the configuration data storage area 32 in the BIOS boot control unit 30.

The operations of the system for user-controlled connection of computer peripheral devices 100 of the present invention in actual implementation are explained using an example below.

In this example, it is assumed that the amount of OPROM original configuration data of the four peripheral devices 51, 52, 53 and 54 are 64 KB, 64 KB, 32 KB, and 24 KB, respectively, and the amount of data after actual execution are 6 KB, 32 KB, 32 KB and 16 KB, respectively. As described in the prior art, if the four PCI peripheral devices are processed in the order of 51→52→53→54, all four PCI peripheral devices can be processed; if they are processed in the order of 52→53→54→51, only the first three peripheral devices can be processed.

Please referring to FIGS. 1 and 2 simultaneously, in actual implementation, after the peripheral devices 51, 52, 53 and 54 10 are inserted to the computer platform, the user activates the process order specifying module 110 in the system for user-controlled connection of computer peripheral devices 100 of the present invention before the BIOS boot procedure is actually performed by the computer platform 10 to show the user control interface 111 on the display 11, so as to allow the user to send a user-controlled process order specifying event 201 via this user control interface 111 for specifying the order in which the peripheral devices 51, 52, 53 and 54 are to be processed (initialized). As described above, if the four PCI peripheral devices are processed in the order of 51→52→53→54, all four PCI peripheral devices can be processed, but if they are processed in the order of 52→53→54→51, only the first three peripheral devices can be processed. Thus, if the order needs to be adjusted, the user may change this process order via the user control interface 111. After specifying the process order, the user may then activate the configuration data source specifying module 120 to show the user control interface 121 on the display 11, so as to allow the user to send a user-controlled configuration data source specifying event 202 for specifying a configuration data source for each of the peripheral devices 51, 52, 53 and 54. The options of the configuration data source may include, for example, a “circuit card OPROM” option and a “main board OPROM” option; wherein the “circuit card OPROM” option represents the OPROM 61, 62, 63 and 64 on the peripheral devices 51, 52, 53 and 54; whereas the “main board OPROM” option represents the configuration data storage area 31, 32, 33 and 34 in the BIOS boot control unit 30. Thereafter, each time the computer platform 10 performs BIOS booting procedure, the configuration data processing module 130 will be activated to perform initialization of the peripheral devices 51, 52, 53 and 54 in the order specified via the process order specifying module 110 and using the configuration data in the configuration data source specified via the configuration data source specifying module 120, so as to enable connection and data exchange between the CPU and the peripheral devices 51, 52, 53 and 54.

In summary, the present invention provides a system and method for user-controlled connection of computer peripheral devices that is connected to a computer platform for allowing users to control the order and the configuration data source of initializing peripheral devices coupled to the computer platform. This allows the computer platform to orderly process the configuration data of the peripheral devices through a Shadow RAM with limited storage and to successfully connect and exchange data with the peripheral devices. In addition, by virtue of the present invention, the computer platform can always support the largest number of peripheral devices possible. Moreover, the processing of configuration data is made more efficient by avoiding conflicts that may cause system hanging phenomenon.

The above embodiments are only used to illustrate the principles of the present invention, and they should not be construed as to limit the present invention in any way. The above embodiments can be modified by those with ordinary skills in the arts without departing from the scope of the present invention as defined in the following appended claims.

What is claimed is:

1. A method for user-controlled connection of computer peripheral devices applicable in a computer platform, the computer platform comprising a Central Processing Unit (CPU), a boot control unit, a shadow Random Access Memory (RAM) and a peripheral connecting interface for connecting to the peripheral devices, each of the peripheral devices having a built-in Option Read Only Memory (OPROM) for storing configuration data of the respective peripheral devices, and the boot control unit having a group of configuration data storage areas built therein in advance, the method comprising:
specifying an order in which the peripheral devices are to be processed by a user;
specifying a configuration data source for each of the peripheral devices by the user, wherein the configuration data source is selected from the group consisting of the OPROM of each of the peripheral devices and the configuration data storage areas in the boot control unit; and
performing initialization for the peripheral devices according to the specified order by reading the required configuration data obtained from the specified configuration data source, so as to allow the CPU to successfully communicate with the peripheral devices.

2. The method for user-controlled connection of computer peripheral devices of claim 1, wherein the computer platform is a network server.

3. The method for user-controlled connection of computer peripheral devices of claim 1, wherein the computer platform is a desktop personal computer.

4. The method for user-controlled connection of computer peripheral devices of claim 1, wherein the computer platform is a notebook computer.

5. The method for user-controlled connection of computer peripheral devices of claim 1, wherein the boot control unit is a Basic Input/Output System (BIOS) chip module.

6. The method for user-controlled connection of computer peripheral devices of claim 1, wherein the peripheral connecting interface is a Peripheral Component Interconnect (PCI) peripheral connecting interface.

7. A system for user-controlled connection of computer peripheral devices, applicable in a computer platform, the computer platform comprising a Central Processing Unit (CPU), a boot control unit, a shadow Random Access Memory (RAM) and a peripheral connecting interface for connecting to the peripheral devices, each of the peripheral devices having a built-in Option Read Only Memory (OPROM) for storing configuration data of the respective peripheral devices, and the boot control unit having a group of configuration data storage areas built therein in advance, the system comprising:
a process order specifying module for allowing a user to specify an order in which the peripheral devices are to be processed;
a configuration data source specifying module for allowing the user to specify a configuration data source for the peripheral devices, wherein the configuration data source is selected from the group consisting of the OPROM of each of the peripheral devices and the configuration data storage areas in the boot control unit; and
a configuration data processing module for performing initialization of the peripheral devices according to the order specified by the process order specifying module by reading the required configuration data obtained from the configuration data source specified by the configuration data source specifying module, so as to allow the CPU to successfully communicate with the peripheral devices.

8. The system for user-controlled connection of computer peripheral devices of claim 7, wherein the computer platform is a network server.

9. The system for user-controlled connection of computer peripheral devices of claim 7, wherein the computer platform is a desktop personal computer.

10. The system for user-controlled connection of computer peripheral devices of claim 7, wherein the computer platform is a notebook computer.

11. The system for user-controlled connection of computer peripheral devices of claim 7, wherein the boot control unit is a Basic Input/Output System (BIOS) chip module.

12. The system for user-controlled connection of computer peripheral devices of claim 7, wherein the peripheral connecting interface is a Peripheral Component Interconnect (PCI) peripheral connecting interface.
